(19) United States
(12) Patent Application Publication
(10) Pub. No.: US 2016/0273656 A1
(43) Pub. Date: Sep. 22, 2016

(54) SHAFT SEAL SYSTEM

(71) Applicant: GM GLOBAL TECHNOLOGY OPERATIONS LLC, Detroit, MI (US)

(72) Inventor: John M. Lopez, Brighton, MI (US)

(21) Appl. No.: 14/662,332

(22) Filed: Mar. 19, 2015

(51) Int. Cl. F16J 15/3236; B60B 27/00; F16J 15/3252

(52) U.S. Cl. CPC F16J 15/3236; F16J 15/3252; B60B 27/0073; B60B 2900/5112

(57) ABSTRACT

A shaft seal system, operable to seal a rotatable shaft in an opening, comprises an inner wall defining the opening having a groove including a first, angled ramp portion and a second, positioning shoulder formed therein. A shaft seal assembly comprises a disc member having an outer diameter and a central opening extending therethrough. An elastomeric material, over-molded onto the disc member, comprises a diaphragm extending generally inwardly from the central opening, to define a shaft opening, a shaft seal lip extending radially inwardly from the diaphragm and an outer ring seal that extends circumferentially about the outer perimeter of the disc member. The shaft seal assembly is installed into the groove in the inner wall of the opening in the housing such that the outer ring seal forms a seal therewith.

### FIELD OF THE INVENTION

The subject of the invention relates to seals for use with rotating components and, more particularly, to a shaft seal system for use with a rotating shaft.

### BACKGROUND

Rotating shafts are used to transfer rotation in numerous applications in industry. In motor vehicles, rotating shafts may be used to transfer rotational forces generated by an internal combustion engine, electric motor or combination thereof, to road wheels for movement of the vehicle. Rotating shafts typically enter and exit assembly housings, containing lubricated components, through shaft openings that require sealing in order to prevent the lubricant from exiting the housing through the shaft opening.

Shaft seal systems have been used between shaft openings and rotatable shafts to prevent the egress of lubricant and to deny ingress, through the shaft opening, of dirt and other contaminants. Such shaft seal systems typically comprise a cup shaped metal case and an inner spring that are both encased in an elastomer that protects the parts as well as forming one or more sealing lips or sealing surfaces that act on both the walls of the shaft opening and the rotating shaft. The function of the cup shaped metal case is to provide the shaft seal with the necessary rigidity to enable a stable coupling with its relative housing opening (i.e. shaft opening wall). However, for each application, a different cup shaped metal case is required due to size and seating performance requirements resulting in cost penalties and long lead times for a relatively simple component.

### SUMMARY OF THE INVENTION

In an exemplary embodiment a shaft seal assembly comprises a disc member having an outer diameter and a central opening extending therethrough. An elastomeric material over-molded onto the disc member comprises a diaphragm extending generally axially inwardly from the central opening in the disc member to define a shaft opening, a shaft seal lip extending radially inwardly from the diaphragm, and an outer ring seal that extends circumferentially about the outer perimeter of the disc member. The shaft seal assembly is configured for installation into a housing opening having a grooved inner wall, such that the outer ring seal enters the groove, to form a seal therewith.

In another exemplary embodiment a shaft seal system, operable to seal a rotatable shaft in an opening of a housing, comprises an inner wall defining the opening and having an undercut groove including a first, angled ramp portion and a second, positioning shoulder formed therein. A shaft seal assembly comprises a disc member having an outer diameter and a central opening extending therethrough. An elastomeric material over-molded onto the disc member comprises a diaphragm extending generally axially inwardly from the central opening in the disc member to define a shaft opening, a shaft seal lip extending radially inwardly from the diaphragm and an outer ring seal that extends circumferentially about the outer perimeter of the disc member. The shaft seal assembly is installed into the undercut groove in the inner wall of the opening in the housing such that the outer ring seal seats against the second, positioning shoulder and forms a first seal therewith and the first, angled ramp portion and forms a second seal therewith.

In yet another exemplary embodiment a shaft seal system, operable to seal a rotatable shaft in an opening of a housing, comprises an inner wall defining the opening and having a groove formed therein. A shaft seal assembly comprises a disc member having an outer diameter and a central opening extending therethrough. An elastomeric material over-molded onto the disc member comprises a diaphragm extending generally axially inwardly from the central opening in the disc member to define a shaft opening, a shaft seal lip extending radially inwardly from the diaphragm and an outer ring seal that extends circumferentially about the outer perimeter of the disc member. The shaft seal assembly is installed into the groove in the inner wall of the opening in the housing such that the outer ring seal forms a seal therewith.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a cross-sectional view of an axle and hub assembly of a motor vehicle embodying features of the invention;

FIG. 2 is a cross-sectional view, of a shaft seal assembly embodying features of the invention; and

FIG. 3 is a partial enlarged view of FIG. 2.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term vehicle is not limited to just an automobile, truck, van or sport utility vehicle, but includes any self-propelled or towed conveyance suitable for transporting a burden. The embodiments shown are applicable to vehicle components, but the system disclosed herein may be used in any suitable applications in which rotating components require sealing in corresponding openings (ex. transportation, energy, machinery and aerospace applications, and particularly including many other types of vehicular components and applications).

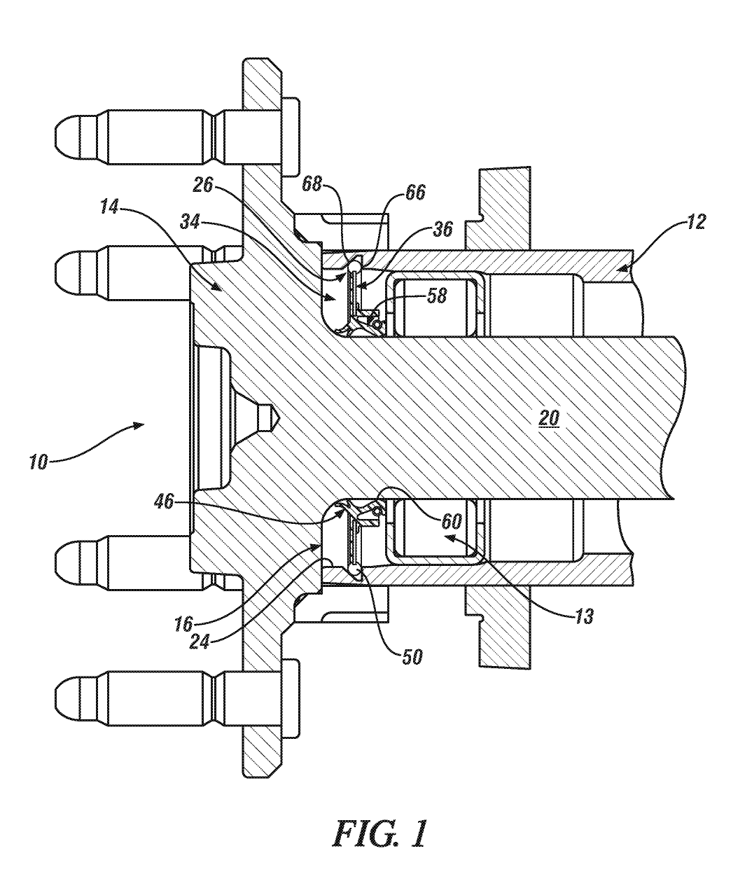

Referring now to FIG. 1, in an exemplary embodiment, a mechanical device 10 is illustrated having a housing 12. The housing of the mechanical device may contain mechanisms for rotation such as bearing assembly 13. In an embodiment, the mechanical device 10 is an axle and hub assembly 14 for application in a motor vehicle. The axle and hub assembly 14 includes at least one cylindrical opening 16 formed therein. The cylindrical opening 16 is configured, as will be described in further detail herein, to receive a rotatable shaft 20. The rotatable shaft 20 may engage gears (not shown) or other drivers that are rotatably operable within the housing 12 to thereby impart a rotation to the shaft 20.

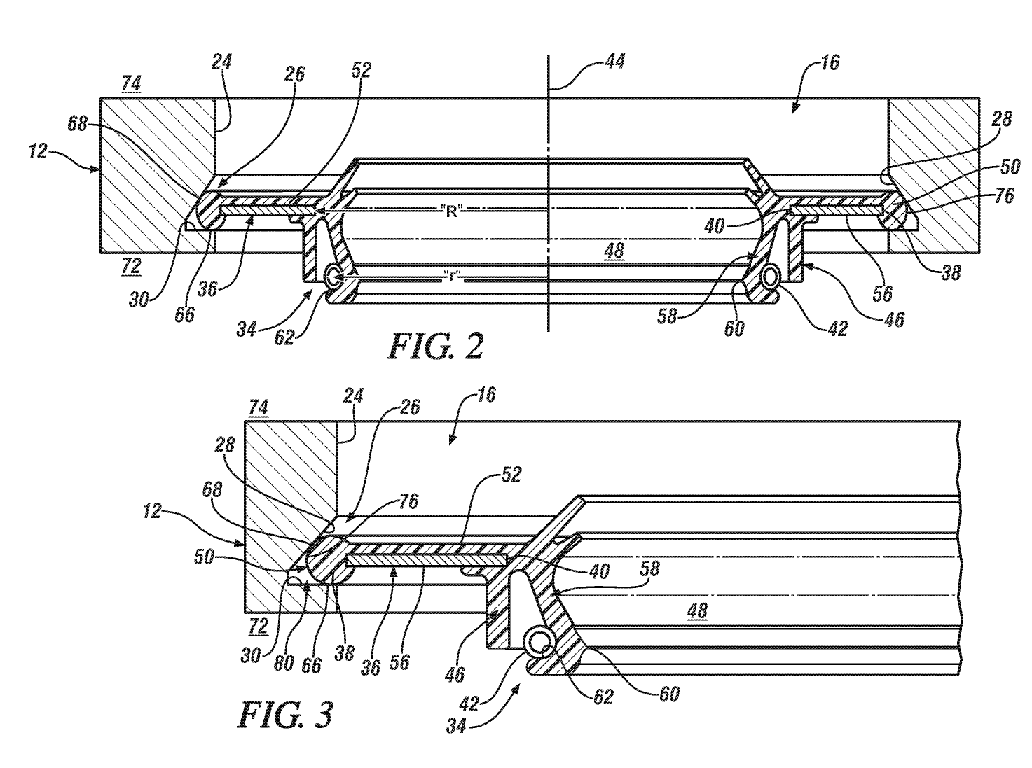

Referring to FIGS. 2 and 3, with continuing reference to FIG. 1, in an embodiment the inner wall 24 of the cylindrical opening 16 includes an undercut groove 26 extending circumferentially thereabout. The undercut groove, 26 in the embodiment illustrated, includes a first, angled approach or ramped portion 28 and a second, positioning shoulder or stop 30. The undercut groove 26, and associated surfaces 28, 30, may be machined into the inner wall 24 of the opening 16 or may be formed into the inner wall 24 during casting of the housing 12.

In an embodiment, a shaft seal assembly 34 comprises a disc member 36 having an outer perimeter 38 and a central opening 40 extending therethrough and having a radius “R”. In an embodiment, the disc member 36 may comprise a washer-like member. A spring member 42, such as a garter spring, is disposed in an axially spaced position from the disc member 36 and has a radius “r”. The disc member 36 and the spring member 42 are aligned such that the radii “R” and “r” share the same central axis 44 of the shaft seal 34. An elastomeric material 46 is, in an embodiment, over-molded onto the disc member 36. The over-molded elastomer may be a mixture of one or more basic elastomers and a variety of ingredients, such as reinforcing fillers, plasticizers, antioxidants, accelerators, etc. This is for the purpose of providing it with certain properties, such as a compatibility with fluid contacted, a high degree of elasticity, a high degree of wear resistance and a low friction coefficient.

The over-molded elastomer 46 defines several features including an outer ring seal 50 that extends circumferentially about the outer perimeter 38 of the disc member 36. The outer ring seal illustrated in FIGS. 2 and 3 defines a circular cross-section to be discussed in further detail herein. In addition, the over-molded elastomer 46 defines a corrosion resistant sealing surface 52 along at least an outer surface 54 of the disc member 36. The inner surface 56 of the disc member may optionally be encapsulated as well. A diaphragm 58 extends generally axially inwardly from the central opening 40 in the disc member 36 to define a shaft opening 48 having a shaft seal lip 60 which may vary in configuration based on individual applications of the shaft seal assembly 34. A spring groove 62 is also molded in a position closely adjacent a rear side of the shaft seal lip 60 and is configured to receive the spring member 42 therein. The spring member 42 has a function that is complementary to the action provided by the shaft seal lip 60. Heat, mechanical deformation and chemical action of fluids in the housing 12 affect the original properties of the elastomeric material 46. As a result, the original radial force exerted by the shaft seal lip 60 may tend to decrease over time. The function of the spring member 42 is to counteract this tendency and to provide stability of the radial sealing force on the rotatable shaft 20.

The shaft seal assembly 34 is installed into the opening 16 of housing 12 such that the outer ring seal 50 enters the undercut groove 26 and is seated on the positioning shoulder 30 to thereby engage in a first sealing line contact 66. The angled approach 28 of the undercut groove guides the shaft seal assembly 34 into position and also assists in retaining the shaft seal assembly 34 against the positioning shoulder 30 by engaging in a second, sealing line contact 68 with the outer ring seal 50. The result is a redundant, double seal between the shaft seal assembly 34 and the wall 24 of the opening 16 between the exterior 74 of the housing 12 and its interior 72 along the inner wall 24. In addition, the second, positioning shoulder 30 orients the shaft seal assembly 34 within the cylindrical opening 16 of the housing 12 and, as such, with the rotatable shaft 20 when inserted therein.

The application of a disc member 36 as the structural member in the shaft seal assembly 34, as disclosed herein, has the advantage of allowing the use of a simpler, stamped support which lends itself to rapid development and low cost manufacture. The disc member 36 does not require the use of expensive, long lead-time progressive dies for manufacture and the investment costs associated therewith. The use of an undercut groove 26, as disclosed herein, provides for simple orientation of the shaft seal 34 with respect to the housing opening 16 and the rotatable shaft 20. Damage to the surface of the outer seal 50, common in seals using cup shaped metal cases is minimized. In the embodiment illustrated, should minor damage occur to the outer edge 76 of the outer ring seal 50 during installation of the shaft seal assembly 34 into the cylindrical opening 16, sealing is unaffected as the seal lines 66 and 68 are unaffected. In an embodiment, the undercut groove 26 may also operate to capture contaminants such as parting line flash that may extend outwardly from the outer edge 76 of the outer ring seal 50. Such flash is a bi-product of the molding process and, normally, if not trimmed prior to seal installation, is subject to entry into the housing 12. In the case of the present shaft seal 34, any dislodged parting line flash is captured in cavity 80 of the undercut groove 26 and is permanently stored between line contact seal 66 and line contact seal 68.

The embodiment of the shaft seal illustrated is only one of numerous configurations contemplated to fall within the scope of the invention. For instance, it is envisioned the features of the over-molded elastomeric material may vary widely. For example the shaft opening 48 may include one or more shaft lip seals 60 and those seals may have numerous configurations. In another embodiment, the outer ring seal 50 may include cross sections other than round. Such cross sections may include oval, lobular (bi-lobular-tri-lobular, etc.), squared, etc. while still performing the required multi-seal function described herein. While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A shaft seal assembly comprising:
a disc member having an outer diameter and a central opening extending therethrough
an elastomeric material over-molded onto the disc member and comprising:
a diaphragm extending generally axially inwardly from the central opening in the disc member to define a shaft opening;
a shaft seal lip extending radially inwardly from the diaphragm; and
an outer ring seal that extends circumferentially about the outer perimeter of the disc member, wherein the shaft seal assembly is configured for installation into a housing opening having a grooved inner wall, such that the outer ring seal enters the groove, to form a seal therewith.

2. The shaft seal assembly of claim 1, wherein the disc member comprises a washer-like member.

3. The shaft seal assembly of claim 1, further comprising
a spring seat molded in the diaphragm adjacent the rear side of the shaft seal lip; and
a spring member disposed in the spring seat.

4. The shaft seal assembly of claim 1, wherein the elastomeric material over-molded onto the disc member comprises a corrosion resistant sealing surface along at least an outer surface of the disc member.

5. The shaft seal assembly of claim 1, wherein the outer ring seal comprises a circular cross-section.

6. The shaft seal assembly of claim 1, wherein the outer ring seal comprises a non-round cross-section.

7. The shaft seal assembly of claim 6, wherein the outer ring seal comprises one of an oval, lobular (bi-lobular-tri-lobular) or squared cross-section.

8. A shaft seal system for sealing a rotatable shaft in an opening of a housing, comprising:
an inner wall defining the opening and having an undercut groove including a first, angled ramp portion and a second, positioning shoulder formed therein;
a shaft seal assembly comprising:
a disc member having an outer diameter and a central opening extending therethrough;
an elastomeric material over-molded onto the disc member and comprising:
a diaphragm extending generally axially inwardly from the central opening in the disc member to define a shaft opening;
a shaft seal lip extending radially inwardly from the diaphragm; and
an outer ring seal that extends circumferentially about the outer perimeter of the disc member;
wherein the shaft seal assembly is installed into the undercut groove in the inner wall of the opening in the housing such that the outer ring seal seats against the second, positioning shoulder and forms a first seal therewith and the first, angled ramp portion and forms a second seal therewith.

9. The shaft seal system of claim 8, wherein the disc member comprises a washer-like member.

10. The shaft seal system of claim 8, wherein the elastomeric material over-molded onto the disc member comprises a corrosion resistant sealing surface along at least an outer surface of the disc member.

11. The shaft seal system of claim 8, wherein the outer ring seal further comprises a circular cross-section.

12. The shaft seal system of claim 8, wherein the outer ring seal comprises a non-round cross-section.

13. The shaft seal system of claim 12, wherein the outer ring seal comprises one of an oval, lobular (bi-lobular-tri-lobular) or squared cross-section.

14. The shaft seal system of claim 8, wherein the undercut groove and the outer ring seal define a cavity that operates to capture and store contaminants therebetween.

15. The shaft seal system of claim 14, wherein the contaminants comprise parting line flash from an outer edge of the outer ring seal.

16. A shaft seal system operable to seal a rotatable shaft in an opening of a housing, comprising:
an inner wall defining the opening and having a groove formed therein;
a shaft seal assembly comprising:
a disc member having an outer diameter and a central opening extending therethrough;
an elastomeric material over-molded onto the disc member and comprising:
a diaphragm extending generally axially inwardly from the central opening in the disc member to define a shaft opening;
a shaft seal lip extending radially inwardly from the diaphragm; and
an outer ring seal that extends circumferentially about the outer perimeter of the disc member;
wherein the shaft seal assembly is installed into the groove in the inner wall of the opening in the housing such that the outer ring seal forms a seal therewith.

17. The shaft seal system of claim 16, wherein the disc member comprises a washer-like member.
